(19) United States
(12) Patent Application Publication
(10) Pub. No.: US 2026/0051268 A1
(43) Pub. Date: Feb. 19, 2026

(54) IDENTIFICATION BADGES, BADGE STOCK AND METHODS OF MAKING INDENTIFICATION BADGES

(71) Applicant: Intellibadge, LLC, Miami, FL (US)

(72) Inventors: Ali Chekhali, Miami, FL (US); Denis Badel, Miami, FL (US)

(21) Appl. No.: 19/275,659

(22) Filed: Jul. 21, 2025

Related U.S. Application Data
(63) Continuation-in-part of application No. 18/622,950, filed on Mar. 31, 2024.

(51) Int. Cl. G09F 3/02; G09F 3/14

(52) U.S. Cl. CPC G09F 3/02883; G09F 3/14; G09F 2003/023; G09F 2003/0269

(57) ABSTRACT

The invention discloses an environmentally conscious identification badge crafted from badge stock made of paper or other composite material, featuring dual surfaces for printing identification information using a designated printer. The identification badge integrates a selective self-adhesive resin or other coating on at least one of its surfaces, ensuring secure bonding when folded without the need for additional fasteners. The identification badge and its badge stock are also designed with the flexibility for one or more perforations for lanyard attachment. The innovation avoids the need for liner paper and simplifies the process and cost of manufacturing durable multi-ply identification badges.

### FIELD OF THE INVENTION

The present invention relates generally to the field of identification badges and printing technologies, specifically the invention relates to self-adhering, liner-less, and durable identification badges, printer stock and methods of manufacturing and using the same.

### BACKGROUND OF THE INVENTION

A significant challenge associated with traditional adhesives used in identification badges is their indiscriminate adhesion to various surfaces. Commonly, adhesives are designed to stick to a range of materials, including plastic, metal, and fabric. While this versatility may be advantageous in certain applications, it presents a notable drawback when considering the specific requirements of identification badges.

Identification badges play a crucial role in various sectors, including corporate, educational, and governmental environments. Traditionally, these badges rely on adhesives to affix securely to clothing or other surfaces. However, a notable challenge has emerged concerning the indiscriminate adhesion properties of these adhesives. The design intent of many adhesives is to exhibit versatility, adhering effectively to a wide array of materials such as plastic, metal, and fabric. While this versatility proves advantageous in numerous applications, it presents a significant limitation in the context of identification badges.

A purpose of an identification badge is to securely affix or associated with a designated surface or object for the duration of its intended use. In many scenarios, badges are subject to movement, handling, and various environmental conditions. Therefore, the adhesive used must not only provide strong initial adhesion but also withstand potential stresses encountered during regular wear. Traditional adhesives, designed with broad material compatibility in mind, may fail to meet the specific requirements of identification badges, leading to issues such as detachment, loss, or damage.

Furthermore, the nature of identification badges necessitates considerations beyond mere adhesion strength. Badges are often subject to frequent removal and replacement, requiring adhesives that can be removed cleanly without leaving residue or causing damage to clothing or surfaces. The indiscriminate adhesion of traditional adhesives may result in adhesive transfer, unsightly residue buildup, or even surface damage upon badge removal. Such outcomes not only diminish the aesthetic appeal of badges but also incur additional costs associated with cleaning or repairing affected surfaces. Consequently, instead of adhering to the object or surface some identification badges are tied or use lanyards.

### SUMMARY OF THE INVENTION

To address the foregoing problems, in whole or in part, and/or other problems that may have been observed by persons skilled in the art, the present disclosure provides compositions and methods as described by way of example as set forth below.

An object of the invention is an identification badge that eliminates the need for plastic pouch holders, liners on printer stock, which in turn also reduces shipment costs and environmental waste.

Another object of the invention is to provide a versatile identification badge solution that accommodates all capable printing technologies, including inkjet and thermal printing.

Another object of the invention is to improve the functionality and design and overall appearance of the identification badges by incorporating features into their printer stock (also referred to as badge stock) such as perforation or drawn fold lines, and a self-adhesive resin or another unique coating on the back adhering solely to itself. Therefore, when used it sticks together and becomes more durable. It also avoids the process and waste associated with using liners for badge stock.

In view of the foregoing, the present invention provides a durable identification badge or badge stock which comprises a paper or paper-like material having a first surface and a second surface, an identification information printed on any one of the first surface or the second surface of the paper material, at least one printer for printing the identification information on the identification badge, and a self-adhesive resin or other similar coating positioned on the backside on any one of the surfaces of the identification badge to maintain the identification badge in a folded state. The identification badge further comprises at least one perforation for receiving lanyards.

In an aspect, the identification badge comprises a perforation fold line facilitating folding of the badge.

In an aspect, the at least one printer is a direct thermal printer.

In an aspect, the perforation fold line includes micro-perforations for facilitating precise and easy folding of the badge. However, some badge stock may use an ink drawn or other visible demarcation line in place of the perforation fold line.

In an aspect, the self-adhesive resin or other coating facilitates secure adhesion in the folded state without the need for additional fasteners or holders.

In an aspect, the invention provides zero, one, two, three or more lanyard slots which are openings or attachments on the badge that allow for the secure attachment of lanyards, which are used for wearing badges around the neck.

The paper material may comprise a traditional paper material made from wood pulp, but may also be crafted from various synthetics and other materials known and to be discovered in the art containing similar properties to paper and card stock, which are suitable for printing.

Additional features of the invention will be or will become apparent to one with skill in the art upon examination of the following FIGURES and detailed description. It is intended that all such additional features and advantages be included within this description, be within the scope of the invention, and be protected by the accompanying claims.

### BRIEF DESCRIPTION OF THE DRAWINGS

Having thus described the subject matter of the present invention in general terms, reference will now be made to the accompanying drawings, which are not necessarily drawn to scale, and wherein:

FIG. 1A illustrates a view of a first surface 102-1 of an identification badge stock, and FIG. 1B illustrates a view of a second surface 102-2 an identification badge stock in accordance with an embodiment of the present invention;

Skilled artisans will appreciate that elements in the drawings are illustrated for simplicity and may not have necessarily been drawn to scale. Furthermore, in terms of the construction of the identification badge and badge stock, one or more components of the identification badge and/or badge stock may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION OF THE INVENTION

The subject matter of the present invention now will be described more fully hereinafter with reference to the accompanying drawings, in which some, but not all embodiments of the subject matter of the present invention are shown. Like numbers refer to like elements throughout. The subject matter of the present invention may be embodied in many different forms and should not be construed as limited to the embodiments set forth herein; rather, these embodiments are provided so that this disclosure will satisfy applicable legal requirements. Indeed, many modifications and other embodiments of the subject matter of the present invention set forth herein will come to mind to one skilled in the art to which the subject matter of the present invention pertains having the benefit of the teachings presented in the foregoing descriptions and the associated drawings. All illustrations of the drawings are for the purpose of describing selected versions of the present invention and are not intended to limit the scope of the present invention. Therefore, it is to be understood that the subject matter of the present invention is not to be limited to the specific embodiments disclosed and that modifications and other embodiments are intended to be included within the scope of the appended claims.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and example of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶ 6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one”, but does not exclude a plurality unless the contextual use dictates otherwise. When used herein to join a list of items, “or” denotes “at least one of the items”, but does not exclude a plurality of items of the list. Finally, when used herein to join a list of items, “and” denotes “all of the items of the list”.

The invention discloses a revolutionary identification badge designed to address critical challenges associated with traditional badge technologies. Departing from the environmentally taxing plastic pouch holders, this innovation embraces sustainability by utilizing paper and composite materials for badge construction. The incorporation of selective self-adhesive resin ensures secure adhesion exclusively to the paper surface, eliminating the risk of unintentional sticking to other surfaces during storage or distribution and further eliminating the need for liner paper such as silicone or wax.

In response to the limitations of existing printing methods, the badge accommodates versatile options, allowing users to choose between direct thermal printing, and other technologies. This flexibility enables on-site customization, fostering adaptability to diverse identification needs. The badge design integrates a perforation fold line for effortless folding, self-adhesive resin for maintaining a folded state without additional fasteners and/or a unique coating system on the back, adhering solely to itself. These features collectively enhance functionality, streamline usage, and eliminate the dependence on plastic pouch holders.

By prioritizing environmental sustainability, and user customization, the invention represents a paradigm shift in the realm of identification badges. This comprehensive solution not only meets the demands of modern identification requirements but also contributes significantly to reducing the ecological footprint associated with conventional badge manufacturing.

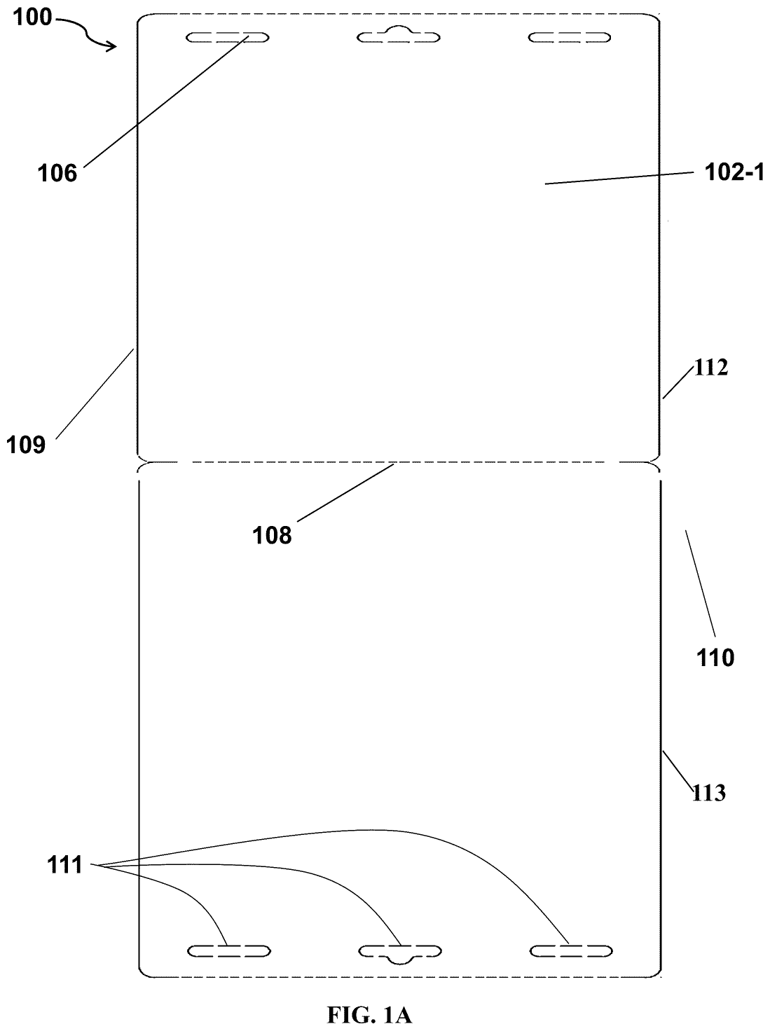

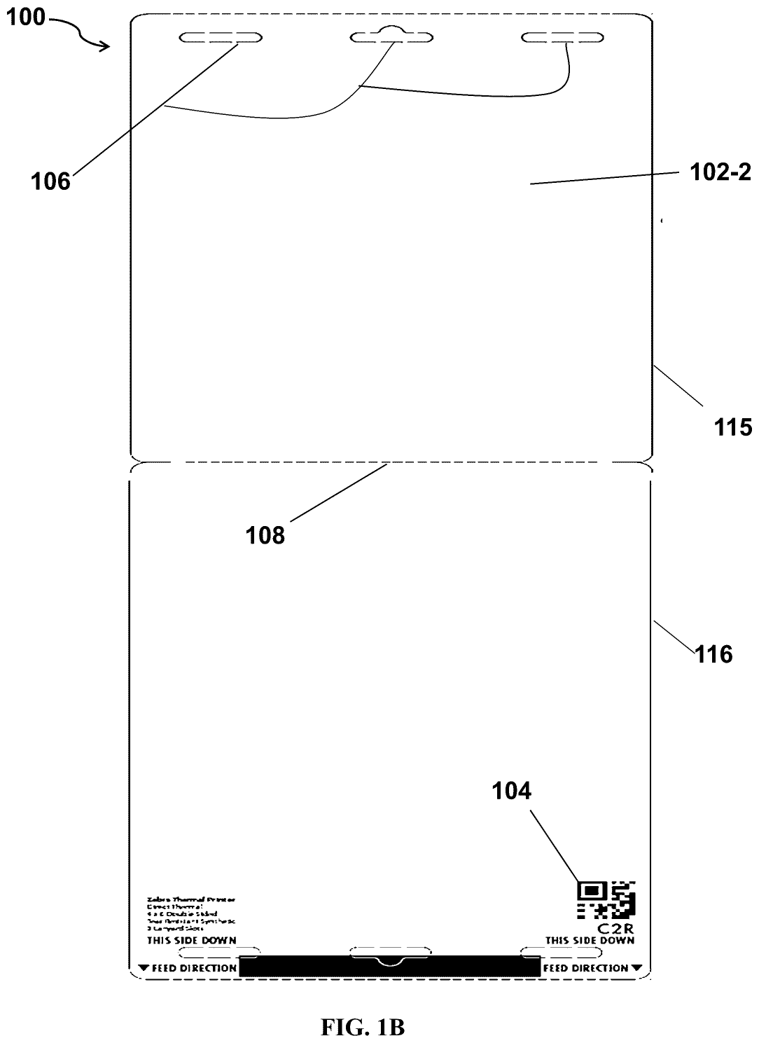

In accordance with an embodiment of the present invention, FIG. 1A illustrates a view of a first surface 102-1 an identification badge 100. FIG. 1B illustrates a view of a second surface 102-2 of an identification badge 100. FIG. 1B further shows the identification information 104 on the second surface of the identification badge 100 and the one or more perforations adapted for receiving lanyards 106. The one or more perforations adapted for receiving lanyards 106 may comprise perforated paper material that may be removed with pressure or may comprise completely punched through or laser cut holes. The identification badge 100 also comprises a perforation fold line 108 facilitating folding of the badge, wherein the first surface 102-1 contains a self-adhering resin or other coating that adheres onto itself. Amongst other things, the self-adhering resin or coating may be activated by contact, pressure, chemical bonding, magnetism, and/or heat. However, cold seal adhesives are generally preferred.

In an embodiment, the identification badge incorporates a feature—a perforation fold line 108 designed to enhance the badge's practicality and ease of use. This perforation fold line 108 is strategically integrated into the badge's structure, providing a predetermined path along which the badge can be neatly and precisely folded.

The introduction of a perforation fold line 108 or drawn fold line is a deliberate design choice that simplifies the process of folding the badge 100, making it more convenient for users. Unlike traditional badges that may require complex folding methods or additional tools, this perforation fold line 108 acts as a predefined guide. Users can effortlessly fold the badge along this line without the need for intricate maneuvers, ensuring a consistently neat fold every time.

This feature is particularly advantageous in scenarios where quick and efficient handling of the identification badge 100 is essential, such as during events, or conferences. The perforation fold line 108 not only facilitates a streamlined folding process but also contributes to the overall user-friendly design of the badge 100, aligning with the invention's objective of providing a versatile and easy-to-use identification solution.

As shown in the drawings, in a preferred embodiment, the perforation fold line 108 is in the center of two symmetrical portions of the badge stock so that a first set of one or more perforations adapted for receiving lanyards 106 line up with a second set of one or more perforations for receiving lanyards 111 when the first inner symmetrical portion of badge stock 112 is folded along the perforation fold line 108 to self-adhere to the second inner symmetrical portion of badge stock 113. This causes the second surface 102-2 to become the outer surface of an identification badge and the first surface 102-1 to self-adhere to form the interior of the identification badge. This consequently causes the resulting identification badge to become multi-ply and more durable. The second surface 102-2 contains first outer symmetrical portion 115 and a second outer symmetrical portion 116 that when the badge stock is folded along the perforation line 108 respectively become the front and the back of an identification badge.

The outer surfaces may contain an organic antiblocking agent selected from polyamides, amide waxes, montan waxes, polyolefin waxes, ester waxes, calcium stearate, zinc stearate, polyvinyl esters, and mixtures thereof. Whereas the interior of the identification badge is formed by the bonding or adherence of the adhesive layer(s).

In some embodiments, the badge stock further comprises a border 109, which may be perforated and a carrier stock 110. This enables multiple smaller identification badges to be printed on stock of standard size paper sizes and to accommodate many different printer technologies. The border also aligns when the badge stock is folded along the perforation fold line 108.

For example, the border 109 of the stock and the perforation fold line 108 may create badges of standard sizes such as CR80 (3.375×2.125 inches); CR79 (83 mm×51 mm); CR100 (100 mm×70 mm); CR50, CR60, CR70, CR90, and/or any other suitable size.

In an embodiment, the at least one printer employed in the identification badge's creation is not limited to a singular type but can encompass multiple technologies such as ink jet, dot matrix, plotter, laser, ink jet and/or thermal.

Generally, direct thermal printing is a method where heat is applied directly to the surface of thermally sensitive paper, causing it to change color and produce the desired print. Generally, inkjet printers utilize liquid ink droplets to create images, while the direct thermal printers use toner powder fused onto the paper through heat.

This flexibility in printer compatibility adds a layer of versatility to the identification badge manufacturing process. Users can choose between inkjet, direct thermal and/or other printers based on specific preferences, cost considerations, or the desired print quality for their identification badges 100. Whether opting for the precision of direct thermal printing or the vibrant colors achievable with inkjet and other technologies, the invention accommodates a range of printing preferences, further enhancing its adaptability to diverse user needs and preferences.

In an embodiment, the identification badge 100 incorporates a composite material as the printing substrate. This composite material, composed of two or more different substances, serves as the surface on which the identification information is printed. The choice of a composite material offers advantages such as durability, flexibility, and customization potential, enhancing the overall resilience and longevity of the badge.

The identification badge utilizing this composite material has the capability to be pre-printed, featuring essential information such as the associated company name. This pre-printing option streamlines the identification process, proving especially beneficial in scenarios where a standardized set of information needs to be present on the badges, such as in corporate or event settings.

In summary, the incorporation of a composite material in the identification badge serves to bolster its durability and customization potential. The ability to be pre-printed with essential information further adds efficiency to the identification process, aligning with the invention's objective of providing a versatile and user-friendly solution for identification purposes.

Further, in a thermal printing process as used in an embodiment of the present invention, a direct method is used where heat is applied to thermally sensitive paper, causing a change in color and resulting in the desired print. However, when discussing thermal transfer printing, a ribbon comes into play. This ribbon acts as a carrier of ink, typically in the form of wax or resin. The printer applies heat to the ribbon, melting the ink, and then transfers the melted ink onto the paper material, creating the final print.

This methodical difference is crucial in understanding the nuanced technologies involved in badge printing. In thermal transfer printing, the inclusion of a ribbon allows for a more controlled and precise application of ink onto the paper. The ink, when melted, adheres to the paper material effectively, producing a high-quality and durable print.

In an embodiment, a notable feature is introduced to the identification badge, offering users a high degree of customization. Specifically, the badge is designed to include a variable number of lanyard slots, providing users with the flexibility to choose between zero slot, one slot, two slots, three slots, or more according to their preferences or specific requirements.

Lanyard slots are designated openings or attachments on the badge that allow for the secure attachment of lanyards, which are commonly used for wearing badges around the neck. The ability to incorporate zero, one, or more lanyard slots is a user-centric feature, acknowledging the diverse preferences and needs of individuals in different settings.

This customization aspect is particularly valuable in scenarios where users may have varying preferences regarding the positioning or distribution of lanyards on the badge. For instance, a user attending a large conference may prefer a badge with two lanyard slots for added stability as the two slots helps in preventing the indentification badge from flipping over, while another user in a different setting may find a single slot more convenient.

By providing a range of options for lanyard slots, the identification badge becomes a versatile solution that can adapt to diverse user preferences. This aligns with the invention's overarching goal of offering a user-friendly and customizable identification solution that caters to the unique needs of individuals across various contexts.

In an embodiment, inclusion of a self-adhesive resin that serves a dual purpose in ensuring both secure adhesion and the maintenance of a folded (multi-ply) state. The self-adhesive resin is strategically integrated into the badge design to eliminate the necessity for supplementary fasteners or holders when the badge is folded. This also eliminates the need for a silicone wax or other liner.

When the identification badge is folded, the self-adhesive resin plays a crucial role in securely holding the folded position. The adhesive nature of the resin creates a strong bond between the layers of the folded badge, preventing unintentional unfolding or displacement. This adhesive functionality not only enhances the badge's structural integrity but also simplifies the user experience by eliminating the need for additional clips or fastening mechanisms.

The badge stock may comprise a topcoat thermal paper with an internal siliconized film and a natural paper. The badge stock laminate in this embodiment is preferred to have a coating that only sticks to itself, an example of stock that may be adapted for this type of use is a cold seal adhesive such as that described in Buchbinder, PCT/EP2000/002528 titled “Tag with cold sealing layer” (filed Mar. 11, 2000 and published as WO2000055832A1 on Sep. 21, 2000) incorporated herein by reference and Buchbinder, U.S. Pat. Appl. No. U.S. Ser. No. 14/028,973 tiled “Multilayer article having cold seal coatings” (filed Sep. 17, 2013) incorporated herein by reference; and other self-adhering methods and coatings known or discovered in the art may be substituted or used.

For further example, in one embodiment, the invention may use a carrier layer selected from paper, plastic films, and a layer of cold seal adhesive, characterized in that the cold seal adhesive is arranged in at least two spaced-apart areas or on the entire surface of the surface of the carrier layer and the selection of the carrier layer may include laminates of paper and plastic films and on the opposite surface of the carrier layer a printable layer containing an organic antiblocking agent selected from polyamides, amide waxes, montan waxes, polyolefin waxes, ester waxes, calcium stearate, zinc stearate, polyvinyl esters, and mixtures thereof.

By removing the reliance on external fasteners or holders, the identification badge becomes more streamlined and user-friendly. Users are spared from the inconvenience of managing separate components to keep the badge securely folded. This feature is especially advantageous in scenarios where individuals need to quickly and efficiently manage their identification badges, contributing to a smoother and more efficient overall identification process.

In an embodiment, the perforation fold line is not a continuous line but rather consists of micro-perforations, which are small and closely spaced perforations designed to enhance the precision and ease of folding the badge. Moreover, these micro-perforations also makes it easier to cut or tear off at the perforations.

Micro-perforations play a crucial role in the folding process by creating a series of closely spaced, tiny holes along the fold line. These holes weaken the material along the designated fold line, making it easier for the user to fold the badge accurately and with minimal effort. The small size and close spacing of the micro-perforations contribute to the creation of a clean and well-defined fold, ensuring that the badge can be neatly and precisely folded along the intended line.

The inclusion of micro-perforations in the perforation fold line addresses the need for a user-friendly and efficient folding mechanism. It minimizes the resistance typically associated with folding a material along a designated line, allowing users to achieve a well-defined fold without the risk of tearing or uneven folding. This feature is particularly advantageous in scenarios where rapid and precise handling of identification badges is essential, such as during events or security checks.

Some of the non-limiting advantages of the present invention are:
Environmental Sustainability: The invention replaces traditional plastic pouch holders with eco-friendly materials such as paper and composite materials, significantly reducing the environmental impact of badge production. By eliminating non-biodegradable plastics, the invention aligns with sustainable practices and contributes to environmental conservation. Further, it eliminates the need for silicone wax paper and/or other liners when creating identification badges.
Versatile Printing Options: Offering compatibility with various printing technologies, including inkjet and direct thermal printing, the invention provides users with the freedom to choose pre-printed or blank badges. This versatility facilitates on-site customization, catering to diverse identification needs and reducing the reliance on pre-manufactured, fixed designs.
Selective Adhesion: The incorporation of a self-adhesive resin with selective adhesion properties ensures that the badge adheres exclusively to its intended paper surface. This feature minimizes the risk of unintentional sticking to other surfaces, enhancing the overall usability and preventing damage during storage, transportation, and distribution.
Streamlined Badge Functionality: The invention introduces features such as perforation fold lines, self-adhesive resin or other self-adhering coating on the back that for secure folding, cutting, tearing and ease of assembly. These elements collectively streamline the badge manufacturing process and improve durability and functionality, eliminating the need for additional holders, clips, or fasteners. Users benefit from a more efficient and user-friendly identification solution.

Terms and phrases used in this document, and variations thereof, unless otherwise expressly stated, should be construed as open-ended as opposed to limiting. As examples of the foregoing: the term “including” should be read as mean “including, without limitation” or the like; the term “example” is used to provide exemplary instances of the item in the discussion, not an exhaustive or limiting list thereof; and adjectives such as “conventional,” “traditional,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although item, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount, or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the subject matter of the present invention. For example, the term “about,” when referring to a value can be meant to encompass variations of, in some embodiments±100%, in some embodiments±50%, in some embodiments±20%, in some embodiments±10%, in some embodiments±5%, in some embodiments±1%, in some embodiments±0.5%, and in some embodiments±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

All publications, patent applications, patents, and other references mentioned in the specification are indicative of the level of those skilled in the art to which the presently disclosed subject matter pertains. All publications, patent applications, patents, and other references are herein incorporated by reference to the same extent as if each individual publication, patent application, patent, and other reference was specifically and individually indicated to be incorporated by reference. It will be understood that, although a number of patent applications, patents, and other references are referred to herein, such reference does not constitute an admission that any of these documents forms part of the common general knowledge in the art. Although the foregoing subject matter has been described in some detail by way of illustration and example for purposes of clarity of understanding, it will be understood by those skilled in the art that certain changes and modifications can be practiced within the scope of the appended claims.

What is claimed:

1. A liner-less identification badge stock comprising:
a paper material having a first surface and a second surface;
a self-adhesive resin positioned on the first surface of the paper material;
the paper material having a fold line adapted for folding the identification badge stock into an identification badge by adhering the first surface to itself.

2. The identification badge stock of claim 1 further comprising one or more of slots for receiving lanyards.

3. The identification badge stock of claim 1 wherein the self-adhesive resin further comprises a cold seal adhesive.

4. The identification badge stock of claim 1 wherein the second surface further comprises a printable layer containing an organic antiblocking agent selected from polyamides, amide waxes, montan waxes, polyolefin waxes, ester waxes, calcium stearate, zinc stearate, polyvinyl esters, and mixtures thereof.

5. The identification badge stock of claim 4 wherein the self-adhesive resin further comprises a cold seal adhesive and the badge stock further comprises one or more slots for receiving lanyards.

6. The identification badge stock of claim 5 wherein the fold line is between two symmetrical portions of an identification badge.

7. The identification badge stock of claim 6 wherein the two symmetrical portions are outlined with a border.

8. The identification badge stock of claim 7 wherein the two symmetrical portions are outlined with a border that is perforated.

9. The identification badge stock of claim 7 wherein the fold line is perforated.

10. The identification badge stock of claim 7 further comprising identification information printed on the second surface.

11. A method of manufacturing an identification badge:
printing identification information on badge stock comprising:
a first surface and a second surface;
a self-adhesive resin positioned on the first surface of the paper material;
the paper material having a fold line adapted for folding the identification badge stock into an identification badge by adhering the first surface to itself; and
folding the badge stock along the fold line so that one or more portions of the first surface self-adheres.

12. The method of manufacturing an identification badge of claim 11 wherein the badge stock further comprises one more slots adapted to receive lanyards.

13. The method of manufacturing an identification badge of claim 11 wherein perforations are made to create one more slots adapted to receive lanyards after the identification badge stock is folded and the one or more portions of the first surface have self-adhered.

14. An identification badge comprising:
a paper material having a first surface and a second surface;
a self-adhesive resin positioned on the first surface of the paper material;
the paper material having a fold line adapted for folding the identification badge stock into an identification badge by adhering the first surface to itself.

15. The identification badge stock of claim 14 wherein the self-adhesive resin further comprises a cold seal adhesive.

16. The identification badge stock of claim 15 wherein the second surface further comprises a printable layer containing an organic antiblocking agent selected from polyamides, amide waxes, montan waxes, polyolefin waxes, ester waxes, calcium stearate, zinc stearate, polyvinyl esters, and mixtures thereof.

17. The identification badge stock of claim 16 wherein the fold line is between two symmetrical portions of an identification badge.

18. The identification badge stock of claim 17 wherein the two symmetrical portions are outlined with a border.

19. The identification badge stock of claim 18 wherein the fold line is perforated.

20. The identification badge stock of claim 1 further comprising identification information printed on the second surface.
